(19) United States
(12) Patent Application Publication
(10) Pub. No.: US 2006/0220981 A1
(43) Pub. Date: Oct. 5, 2006

(54) Information processing system and information processing method

(75) Inventors: Kazumasa Murai, Kanagawa (JP); Takemi Yamazaki, Kanagawa (JP); Jun Miyzaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/219,687

(22) Filed: Sep. 7, 2005

(30) Foreign Application Priority Data
Mar. 29, 2005 (JP) 2005-094913

(51) Int. Cl. G09G 5/00

(52) U.S. Cl. 345/1.1

(57) ABSTRACT

There is provided an information processing system including multiple controlled devices respectively having display areas and a controlling device that controls the controlled devices to display given images in the display areas thereof and that identifies positions of the display areas on the basis of image information including the display areas. It is therefore possible to identify the positions of the display areas.

### BACKGROUND OF THE INVENTION

1. Field of the Invention

This invention relates to an information processing system and an information processing method.

2. Description of the Related Art

Conventionally, there has been proposed a device that can automatically recognize a pointing position in a display area. This device is designed to detect the pointing position by detecting a given position in a shadow area or real area, which is an image area in a pointed image included in a pickup area, as the pointing position, on the basis of a pickup signal captured by a CCD camera the display area in which an image is displayed, as seen in Japanese Patent Application Publication No. 11-345086 (hereinafter referred to as Document 1).

There has been also proposed an electronic conferencing system, as seen in Japanese Patent Application Publication No. 2002-281468 (hereinafter referred to as Document 2). In this system, the positions of the participants and peripheral equipment are automatically measured to display icons thereof on a virtual display device. The positional relationship of information terminals and other information devices included in this conferencing system is calculated on the basis of a delay time in reception of a wireless radio wave to display the arrangement of the information devices visually on the basis of the positional relationship of the information devices obtained as a part of the common display. In addition, Japanese Patent Application Publication No. 2004-110821 (hereinafter referred to as Document 3) has proposed a system in which multiple display devices recognize other display devices nearby or at a remote location.

Document 3, however, has the problem in that automatic calibration is unavailable. The display area has to be designated in a rectangle to discern the position of a target to be controlled in the image.

### SUMMARY OF THE INVENTION

The present invention has been made in view of the above circumstances and provides an information processing system and information processing method, in which automatic calibration is available to designate where a device to be controlled is located in an image captured by a camera.

According to one aspect of the present invention, there may be provided an information processing system including multiple controlled devices respectively having display areas, and a controlling device that controls the controlled devices to display given images in the display areas thereof and that identifies positions of the display areas on the basis of image information in which an area including the display areas has been captured by an image-capturing apparatus.

According to another aspect of the present invention, there may be provided an information processing method including displaying given images respectively in display areas of multiple controlled devices, and identifying positions of the display areas on the basis of image information in which an area including the display areas has been captured by an image-capturing apparatus. It is therefore possible to identify the positions of the display areas.

### BRIEF DESCRIPTION OF THE DRAWINGS

Embodiments of the present invention will be described in detail based on the following figures, wherein:

FIG. 1 is a view showing a system configuration;

FIG. 2 is a view showing an image captured by a panoramic view camera 32;

FIG. 3 is a flow chart showing the process of the controlling device;

FIG. 4 is a flowchart showing the process to identify a device with a controlled image in step S107 shown in FIG. 3;

FIG. 5 is a view showing how to identify the device with the controlled image;

FIG. 6 is a flowchart showing the process to identify the device with a sound source in step S108 shown in FIG. 3;

FIG. 7 is a graph showing how to identify the device with the sound source;

FIG. 8 is a flowchart showing the process to identify the device having an optical characteristic in step S109 shown in FIG. 3;

FIG. 9A is a view showing a bead type of retroreflective marker 71 and a prism type of retroreflective marker 72;

FIG. 9B is a view showing a barcode 73 in which an identifier of the device is recorded; and

FIG. 9C shows the panoramic view camera 32 with a light source 33 arranged near by.

### DESCRIPTION OF THE EMBODIMENTS

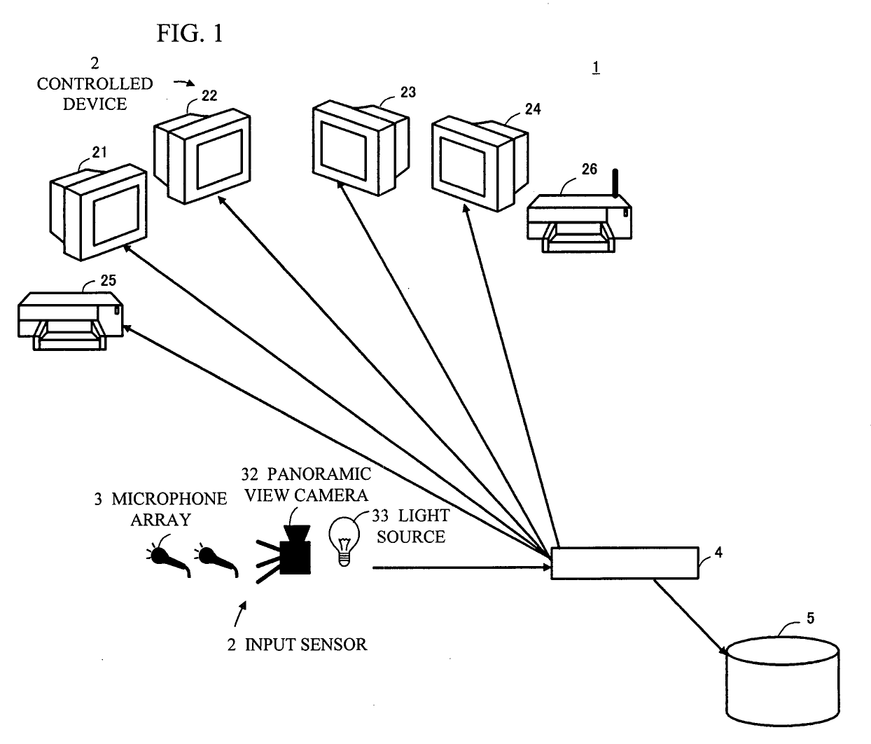

A description will now be given, with reference to the accompanying drawings, of embodiments of the present invention. FIG. 1 is a view showing a system configuration. Referring to FIG. 1, a system (information processing system) 1 includes a controlled device 2, an input sensor 3, a controlling device 4, and a database 5. The system 1 is used for automatically obtaining and calibrating aspect ratios in a display and positional information of the devices. Each of the controlled devices (the devices to be controlled) 2 is automatically calibrated to indicate where they are in an image captured by a panoramic view camera.

The controlled device 2 includes a display area and/or retroreflective marker. The retroreflective marker denotes a marker in which a portion not reflective is segmented in stripes. Some of the controlled devices 2 makes a sound. The controlled devices 2 include, for example, displays 21 through 24, and printers 25 and 26. The displays 21 through 24 are configured to include a display area in which a given image is displayed. The input sensor 3 includes a microphone array 31, a panoramic view camera 32, and a light source 33. The microphone array 31 gathers the sound made by the controlled device 2 and outputs sound source information to the controlling device 4. The panoramic view camera 32 captures the display areas of the displays 21 through 24, which are displaying the given images, and outputs image information captured to the controlling device 4.

The controlling device 4 is configured by, for example, a personal computer, controls to show the given image in the display areas of the displays 21 through 24, and identifies the positions of the display areas on the basis of the image information in which the area including the display area has been captured. Here, the controlling device 4 displays different images in the display areas of the displays 21 through 24. The image to be processed includes a moving image or the image in simple colors. If the moving image is processed, it is desirable to use a pattern of sequentially displaying multiple colors or a simple color pattern of indicating corners of the image. The controlling device 4 sequentially displays the images having different patterns from one another, in calibrating the multiple displays 21 through 24.

In addition, the controlling device 4 identifies the position of the controlled device 2 on the basis of the sound information of the sounds made by the controlled device 2 and obtained by the microphone array. Here, if there are multiple controlled devices 2, the controlling device 4 controls the controlled devices 2 to make different sounds from one another. The sounds made by the controlled device 2 include sounds that can be controlled by the controlling device 4 and operating sounds of the controlled device 2. The controlling device 4 identifies the position of the controlled device 2 having the retroreflective marker according to the light reflected by the marker. When the controlled device 2 emits at least one of light, electromagnetic wave, and sound of a given pattern, the controlling device 4 detects the pattern emitted by the controlled device 2 to identify the position of thereof.

The controlling device 4 identifies the controlled device 2 and the position thereof on the basis of the image information in which the controlled device 2 is captured and information on a shape of the controlled device 2 having a given shape stored in the database 5. The database 5 corresponds to a memory portion.

The controlling device 4 automatically associates the positional information of the controlled device 2 in the image captured by the panoramic view camera 32 with each of the devices, and stores in the database 5. The positional information includes the display area in each of the device and areas of positions of the printer, microphone, speaker, or the like. The controlling device 4 identifies the position of the controlled device 2 according to the sound information obtained from the microphone array 31. The controlling device 4 identifies the position of the controlled device 2 according to the electromagnetic wave reflected by the above-mentioned marker.

Furthermore, the controlling device 4 identifies the position of the controlled device 2 by detecting the light emitted thereby. The controlling device 4 detects the position of the controlled device 2 by detecting an image characteristic of the controlled device 2 or a barcode or the like attached to the controlled device 2 with the panoramic view camera 32. The database 5 stores information on the image characteristic, namely, information of the shape of the controlled device 2 and the barcode attached to the controlled device 2, in advance. The controlling device 4 identifies the position of the controlled device 2 on the basis of the image information in which the controlled device 2 is captured and the information on the shape of the controlled device 2 and the information on the barcode stored in the database 5.

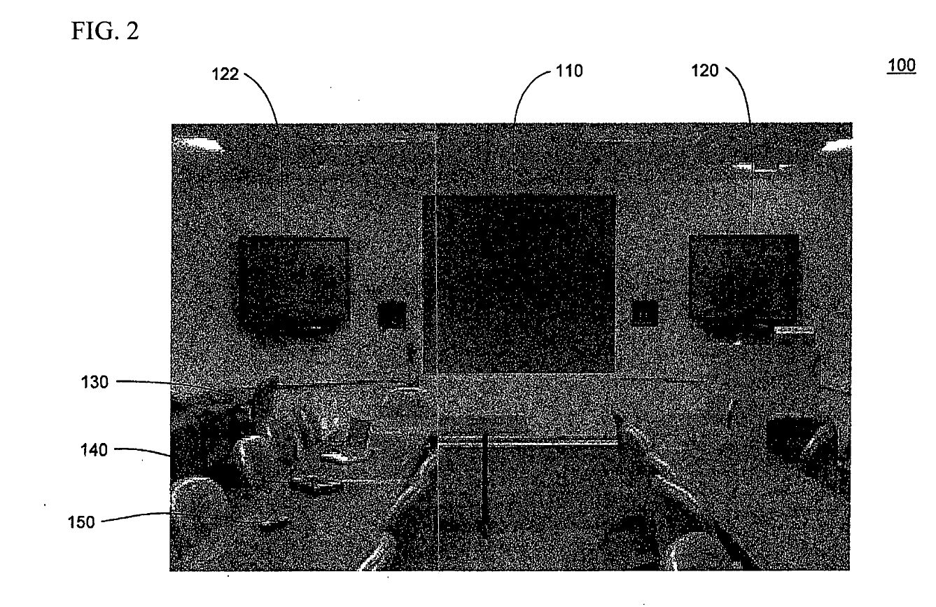

FIG. 2 is a view showing an image captured by the panoramic view camera 32. An environment 100 includes display devices 110, 120, and 122, a notebook computer 130, a tablet PC 140, and a PDA 150, which are shown and set up in a conference room. Generally, the display devices 110, 120, and 122 are fixed, but mobile devices 130, 140, and 150 can be moved in the environment 100. The display devices 110, 120, and 122 correspond to the displays 21 through 24 including the display areas shown in FIG. 1. Assuming that the printer and the micro speaker are not shown, but are also captured in the image of the panoramic view camera 32.

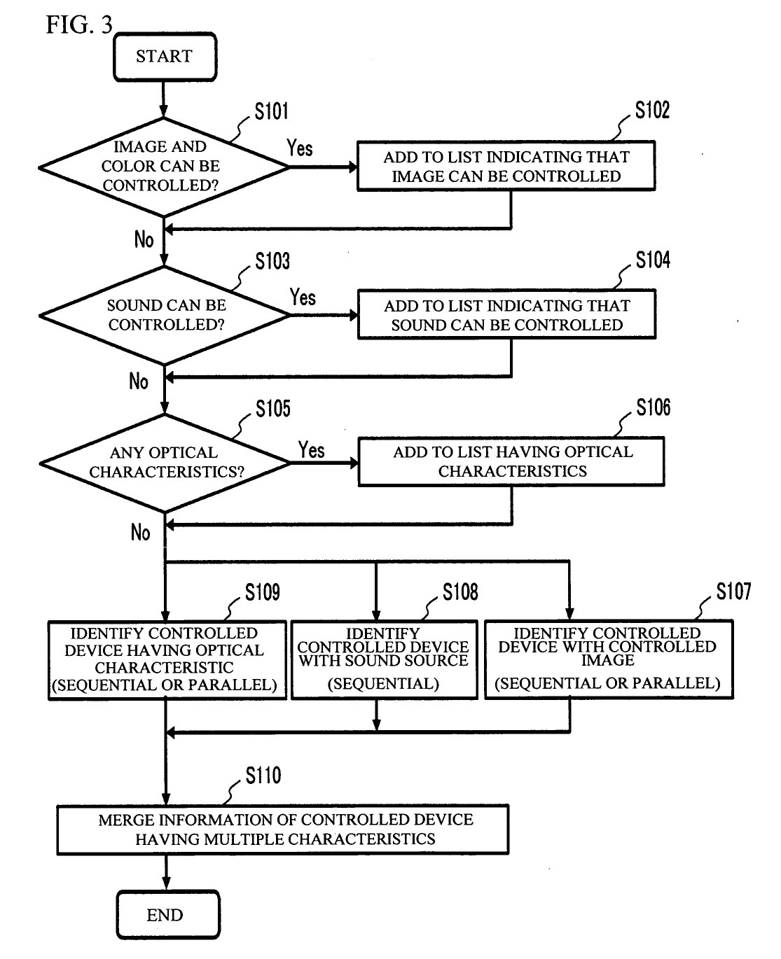

Next, a description will be given of the process flow of the controlling device 4. FIG. 3 is a flowchart showing the process of the controlling device 4. The controlling device 4 determines whether the image and color shown in the display area of the controlled device 2 can be controlled, in step S101. If the controlling device 4 determines that the image and color shown in the display area of the controlled device 2 can be controlled, the controlling device 4 adds the controlled device 2 to a list of devices including that the image thereof can be controlled, instep S102. If the controlling device 4 determines that the image and color shown in the display area of the controlled device 2 cannot be controlled, the controlling device 4 determines whether the sound can be controlled in step S103. If the controlling device 4 determines that the sound can be controlled, the controlling device 4 adds the controlled device 2 to another list of devices including that the sound thereof can be controlled, in step S104.

If the controlling device 4 determines that the sound cannot be controlled in step S103, the controlling device 4 determines whether the controlled device 2 has an optical characteristic in step S105. If the controlling device 4 determines that the controlled device 2 has the optical characteristic, the controlling device 4 adds the controlled device 2 to further another list of devices having the optical characteristic, in step S106. If the controlling device 4 determines that the controlled device 2 does not have the optical characteristic in step S105, the controlling device 4 identifies the device with the controlled image in step S107, identifies the device with the sound source in step S108, and identifies the device having the optical characteristic in step S109, and then goes to step S110. The controlling device 4 merges the information if one device has multiple characteristics, and completes the process.

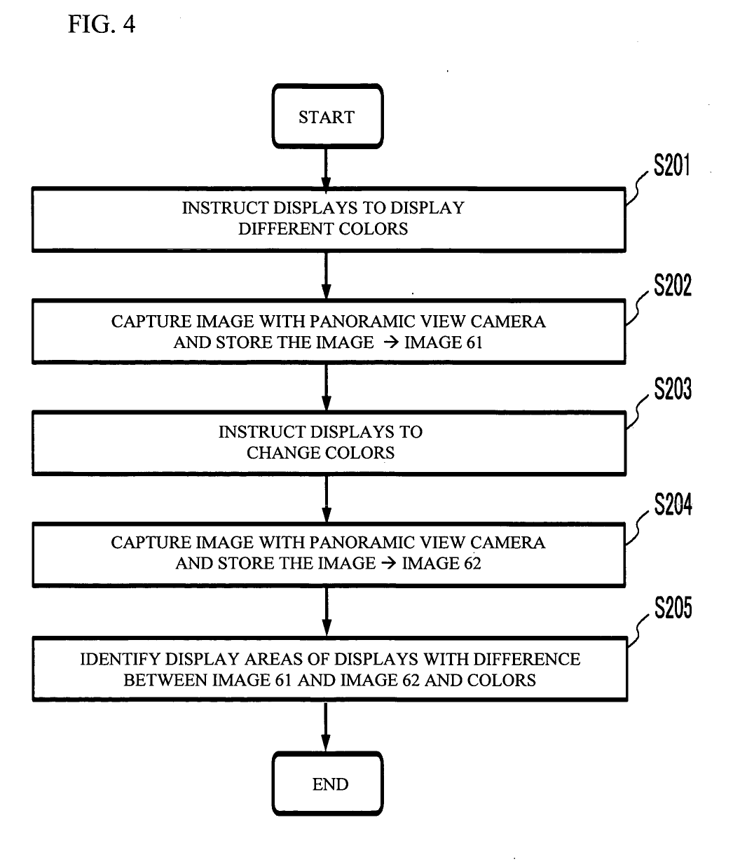

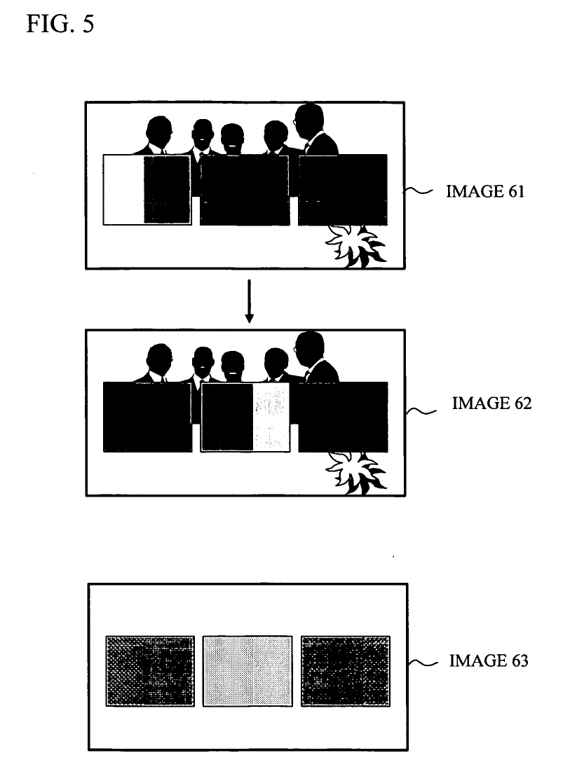

FIG. 4 is a flowchart showing the process to identify the device with the controlled image in step S107 shown in FIG. 3. FIG. 5 is a view showing how to identify the device with the controlled image. The aforementioned processes can be performed sequentially or in parallel. The controlling device 4 instructs the displays 21 through 24 to display different colors in step S201. The controlling device captures an image with the panoramic view camera 32, and stores the image as an image 61 in step S202.

The controlling device 4 instructs the displays 21 through 24 to change the colors in step S203. The controlling device 4 captures the image with the panoramic view camera 32, and stores the image as an image 62 in step S204. The controlling device 4 calculates a difference between an RGB value of the image 62 and that of the image 61 in every pixel to obtain an image 63, and identifies the display areas of the displays 21 through 24. In this manner, the positions of the displays 21 through 24 can be identified.

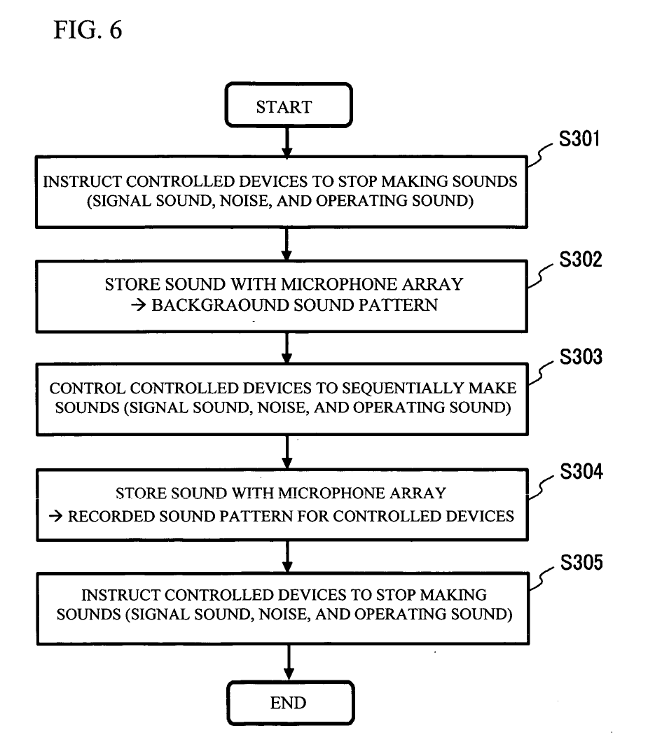

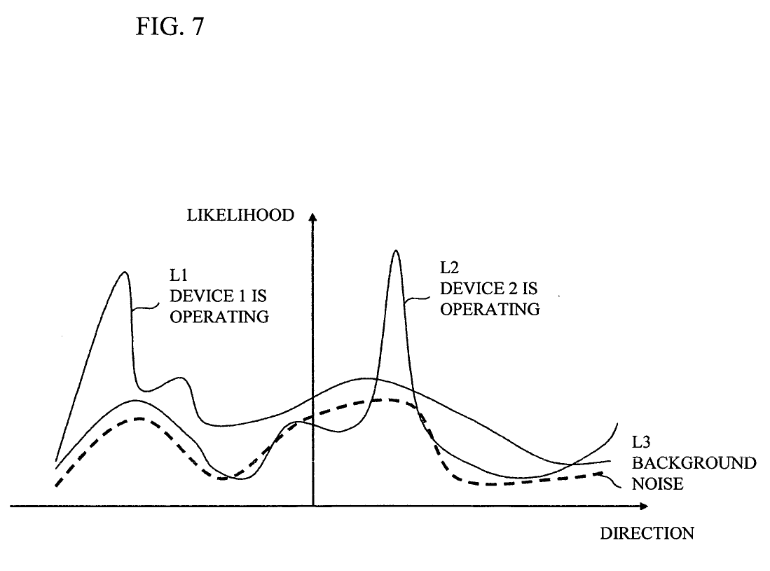

FIG. 6 is a flowchart showing the process to identify the device with the sound source in step S108 shown in FIG. 3. This process can be performed sequentially. FIG. 7 is a graph showing how to identify the device with the sound source. In FIG. 7, the horizontal axis denotes direction and the vertical axis denotes likelihood. L1 denotes an operation of a device 1, L2 denotes the operation of a device 2, and L3 denotes background noise. With the microphone array, a sound strength varies depending on the direction, and can be observed with a difference in arrival times of the sound. Two or more microphones are set in line and the relation of input sound signals is obtained. The correlation coefficient is calculated while the time corresponding to the arrival time is being delayed or shifted. The likelihood, which varies depending on the direction, is obtainable.

The controlling device 4 instructs the devices to stop the signal sound, noise, and operating sound in step S301. The controlling device 4 stores the sounds with the microphone array 31 to obtain a background sound pattern in step S302. The controlling device 4 controls the controlled device 2 to sequentially make the sounds such as the signal sound, noise, and operating sound in step S303. The controlling device 4 stores the sounds with the microphone array 31 to obtain a recorded sound pattern for every device in step S304. The controlling device 4 compares the background sound pattern and the recorded sound pattern for every device to calculate the likelihood varying depending on the direction. In this manner, the controlled device 2 making a sound can be identified.

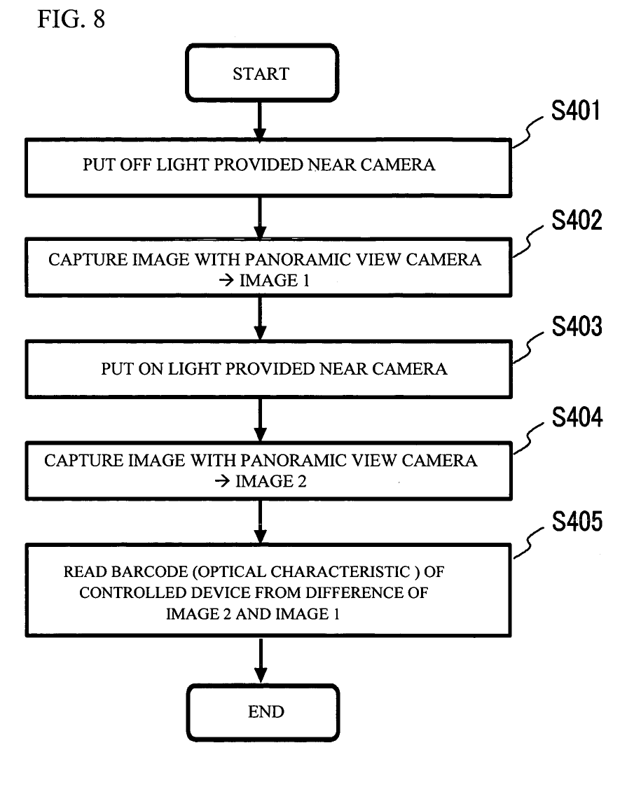

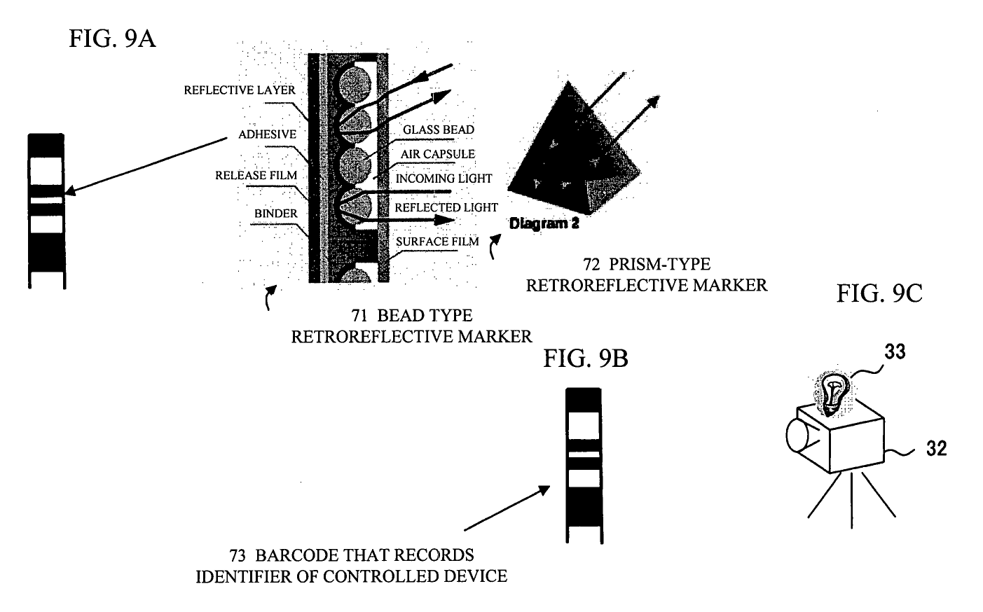

FIG. 8 is a flowchart showing the process to identify the device having the optical characteristic in step S109 shown in FIG. 3. This process can be performed sequentially or in parallel. FIGS. 9A through 9C are views showing how to identify the device having the optical characteristic. FIG. 9A is a view showing a bead type of retroreflective marker 71 and a prism type of retroreflective marker 72. FIG. 9B is a view showing a barcode 73 in which an identifier of the device is recorded. FIG. 9C shows the panoramic view camera 32 with the light source 33 arranged nearby. As shown in FIG. 9A, the retroreflective marker reflects the light toward an incident direction thereof with a prism or beads. As shown in FIG. 9C, when the light is shone from the light source 33 provided near the camera 32, the light is reflected on the retroreflective markers 71 and 72, and then the light enters the camera 32. For example, the camera 32 is configured to include a filter that passes infrared rays only. When a relatively strong infrared light is used, the pickup image in which the marker stands out is obtainable.

In addition, the affect of other infrared rays, for example, sunlight can be reduced by turning on and off the light source 33 and detecting the difference. Furthermore, the barcode 73 that stores an identifier of the controlled device is attached to the controlled device 2. This barcode 73 is captured by the panoramic view camera 32 to identify the position of the barcode 73. Then, the position of the controlled device 2 is obtainable. As described above, the system1 includes the light source 33 provided in an optical axis or near the panoramic view camera 32. The controlling device 4 obtains first image information of the light emitted from the light source 33 and second image information in which the light is not emitted from the light source 33 with the use of the panoramic view camera 32 in order to detect the difference between the first and second image information. This makes it possible to reduce the affect made by other infrared rays, for example, sunlight.

As shown in FIG. 8, the controlling device 4 puts off the light source 33 provided near the panoramic view camera 32 in step S401. The controlling device 4 captures the image with the panoramic view camera 32 to obtain an image 1 in step S402. The controlling device 4 puts on the light source 33 provided near the panoramic view camera 32 in step S403. The controlling device 4 captures the image with the panoramic view camera 32 to obtain an image 2 in step S404. The controlling device 4 reads the barcode 73 of the device with the difference of the images 1 and 2 in step S405. This makes it possible to identify the position of the controlled device 2 corresponding to the barcode 73.

The above-mentioned information processing system may further include a controlled device that makes a given sound. The controlling device may identify a position of the controlled device that makes the given sound on the basis of sound information obtained from the sound made by the controlled device. The sound made by the controlled device may include at least one of a sound that can be controlled by the controlling device and an operating sound of the controlled device. The sound may include not only the sound that can be controlled such as a speaker or an ultrasonic transducer but also the operating sound of the machine, and noises.

On the information processing system in the above-mentioned aspect, if there are multiple controlled devices that make sounds, the controlling device may control the multiple controlled devices to make different sounds from one another. The microphone array is one of the most possible methods of detecting the sound source, and a position sensor may be employed. In addition, the position can be estimated from the sound volume by providing multiple microphones. The controlled device is made to make sounds by controlling the device to operate or stop, even in the operating sound or the noise.

The above-mentioned information processing system may further include multiple controlled devices that make at least one of light, electromagnetic wave, and sound in a given pattern. The controlling device may identify a position of the controlled device by detecting the pattern made by the controlled device. The pattern may be a combination of the light and sound. The electromagnetic wave is applicable. For example, the electromagnetic wave and the ultrasonic wave are simultaneously emitted, and the waves are received by a sensor remotely provided. The sonic wave reaches later than the electric wave, and this enables measurement of the distance between the device and the sensor. Moreover, multiple sensors enables a triangular surveying.

On the information processing system in the above-mentioned aspect, the images may include a moving image. The images may have simple colors. It is possible to distinguish respective display areas by displaying colors. The images may have a color pattern that sequentially shows multiple simple colors. It is possible to recognize the display area by sequentially displaying the multiple colors, even if there is a portion of the same color other than the display area. The image may have a color pattern that shows corners of a display. This allows to recognize the direction of the display area and display direction.

On the information processing system in the above-mentioned aspect, a portion that is not reflective in the retroreflective marker may be segmented in stripes. In addition to affixing a retroreflective material in stripes, the retroreflective material may be blocked in stripes. A black tape maybe affixed in stripes, or a patterned OHP sheet printed in black may be affixed.

The above-mentioned information processing system may further include an image-capturing apparatus, and a light source arranged in an optical axis or near the image-capturing apparatus. The image-capturing apparatus may obtain first image information when a light is emitted from the light source and second image information when the light is not emitted from the light source from the image-capturing apparatus, and detects a difference between the first and second image information. This makes it possible to reduce the affect of other infrared rays such as the sunlight.

The information processing method of the present invention is realized with a CPU (Central Processing Unit), ROM (Read Only Memory), RAM (Random Access Memory), and the like, by installing a program from a portable memory device or a storage device such as a hard disc device, CD-ROM, DVD, or a flexible disc or downloading the program through a communications line. Then the steps of program are executed as the CPU operates the program.

Although a few embodiments of the present invention have been shown and described, it would be appreciated by those skilled in the art that changes may be made in these embodiments without departing from the principles and spirit of the invention, the scope of which is defined in the claims and their equivalents.

The entire disclosure of Japanese Patent Application No. 2005-094913 filed on Mar. 29, 2005 including specification, claims, drawings, and abstract is incorporated herein by reference in its entirety.

What is claimed is:

1. An information processing system comprising:
multiple controlled devices respectively having display areas; and
a controlling device that controls the controlled devices to display given images in the display areas thereof and that identifies positions of the display areas on the basis of image information in which an area including the display areas has been captured.

2. The information processing system as claimed in claim 1, wherein the controlling device respectively displays different images in the display areas of the controlled devices.

3. The information processing system as claimed in claim 1, further comprising a controlled device that makes a given sound,
wherein the controlling device identifies a position of the controlled device that makes the given sound on the basis of sound information obtained from the sound made by the controlled device.

4. The information processing system as claimed in claim 3, wherein the sound made by the controlled device includes at least one of a sound that can be controlled by the controlling device and an operating sound of the controlled device.

5. The information processing system as claimed in claim 3, wherein the sound information is obtained by using a microphone array.

6. The information processing system as claimed in claim 3, wherein if there are multiple controlled devices that make sounds, the controlling device controls the multiple controlled devices to make different sounds from one another.

7. The information processing system as claimed in claim 1, further comprising a controlled device having a retroreflective marker,
wherein the controlling device identifies a position of the controlled device having the retroreflective marker on the basis of a light reflected by the retroreflective marker.

8. The information processing system as claimed in claim 1, further comprising multiple controlled devices that make at least one of light, electromagnetic wave, and sound in a given pattern,
wherein the controlling device identifies a position of the controlled device by detecting the pattern made by the controlled device.

9. The information processing system as claimed in claim 1, further comprising:
a controlled device having a given shape; and
a recording portion that stores information on the shape of the controlled device having the given shape,
wherein the controlling device identifies the position of the controlled device having the given shape on the basis of the image information in which the controlled device having the given shape is captured and the information on the shape of the controlled device stored in the memory portion.

10. The information processing system as claimed in claim 1, wherein the images include a moving image.

11. The information processing system as claimed in claim 1, wherein the images have simple colors.

12. The information processing system as claimed in claim 1, wherein the images have a color pattern that sequentially shows multiple simple colors.

13. The information processing system as claimed in claim 1, wherein the image has a color pattern that shows corners of a display.

14. The information processing system as claimed in claim 1, wherein the images having different patterns from one another are sequentially displayed in the display areas on the controlled devices.

15. The information processing system as claimed in claim 7, wherein a portion that is not reflective in the retroreflective marker is segmented in stripes.

16. The information processing system as claimed in claim 7, further comprising:
an image-capturing apparatus; and
a light source arranged in an optical axis or near the image-capturing apparatus,
wherein the image-capturing apparatus obtains first image information when a light is emitted from the light source and second image information when the light is not emitted from the light source from the image-capturing apparatus, and detects a difference between the first and second image information.

17. An information processing method comprising:
displaying given images respectively in display areas of multiple controlled devices; and
identifying positions of the display areas on the basis of image information in which an area including the display areas has been captured by an image-capturing apparatus.

18. The information processing method as claimed in claim 17, further comprising:
obtaining sound information on the basis of a sound made by a controlled device; and
identifying a position of the controlled device that makes a given sound on the basis of the sound information.

19. The information processing method as claimed in claim 17, further comprising identifying a position of a controlled device on the basis of a light reflected by a retroreflective marker included in the controlled device.
